(19) United States
(12) Patent Application Publication
(10) Pub. No.: US 2026/0044545 A1
(43) Pub. Date: Feb. 12, 2026

(54) SYSTEMS, METHODS, AND APPARATUSES FOR EXTRACTING RELIABLE PREDICTIVE OUTPUTS FROM LARGE LANGUAGE MODELS

(71) Applicant: University of Florida Research Foundation, Incorporated, Gainesville, FL (US)

(72) Inventors: Jose Fortes, Gainesville, FL (US); Michael Elliott, Gainesville, FL (US)

(21) Appl. No.: 19/291,740

(22) Filed: Aug. 6, 2025

Related U.S. Application Data
(60) Provisional application No. 63/680,147, filed on Aug. 7, 2024.

(51) Int. Cl. G06F 16/334; G06F 40/284

(52) U.S. Cl. CPC G06F 16/334; G06F 40/284

(57) ABSTRACT

Methods, apparatuses, and systems are directed to generating a predictive response and a set of token scores by applying a natural language query to a large language model, generating a prediction model based on the predictive response and a classifier, wherein the prediction model is configured to generate a predicted answer to the natural language query, and wherein the classifier is configured to weigh the predicted answer based on the set of token scores, determining one or more uncertainty measures, generating a confidence machine learning model based on the one or more uncertainty measures, determining a confidence feature by applying the natural language query and the predicted answer to confidence machine learning model, and determining a reliability feature of the predicted answer based on the confidence feature and a confidence threshold.

### CROSS REFERENCE TO RELATED APPLICATION

This application claims the benefit of U.S. Provisional Application No. 63/680,147, filed Aug. 7, 2024.

### SUPPORT STATEMENT

This invention was made with government support under 2027654 awarded by the National Science Foundation. The government has certain rights in the invention.

### TECHNICAL FIELD

The present disclosure relates to extracting reliable predictive outputs from large language models.

### BACKGROUND

Large Language Models (LLMs) are able to process and generate natural language text. However, despite significant advancements in learning capabilities of LLMs, state-of-the-art LLMs often generate information that is factually incorrect. This unreliability precludes the use of LLMs in practical applications that have a low tolerance for factual errors.

### BRIEF DESCRIPTION OF THE DRAWINGS

So that the present disclosure can be understood by those of ordinary skill in the art, a more detailed description can be had by reference to aspects of some illustrative embodiments, some of which are shown in the accompanying drawings.

FIG. 1 is a simplified illustration of an exemplary implementation of an exemplary architecture, in accordance with one or more embodiments of the present disclosure;

FIG. 2 shows a basic block diagram of an exemplary architecture of a reliable output extraction system, in accordance with one or more embodiments of the present disclosure;

FIG. 3 illustrates an example data flow for reliable output extraction in accordance with one or more embodiments of the present disclosure;

FIG. 4 illustrates an example measurement of reliable output extraction performance in accordance with one or more embodiments of the present disclosure;

FIG. 5 illustrates another example measurement of reliable output extraction performance in accordance with one or more embodiments of the present disclosure; and

FIG. 6 illustrates an example illustration of reliable output extraction performance in accordance with one or more embodiments of the present disclosure.

In accordance with common practice, some features illustrated in the drawings cannot be drawn to scale. Accordingly, the dimensions of some features can be arbitrarily expanded or reduced for clarity. In addition, some of the drawings cannot depict all the components of a given system, method or device. Finally, like reference numerals can be used to denote like features throughout the specification and figures.

### DETAILED DESCRIPTION OF VARIOUS EMBODIMENTS

This disclosure is generally related to extracting reliable predictive outputs from LLMs. Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means including but not limited to and should be interpreted in the manner it is typically used in the patent context. The phrases “in one embodiment,” “according to one embodiment,” and the like generally mean that the particular feature, structure, or characteristic following the phrase may be included in at least one embodiment of the present invention and may be included in more than one embodiment of the present disclosure (importantly, such phrases do not necessarily refer to the same embodiment). If the specification describes something as “exemplary” or an “example,” it should be understood that refers to a non-exclusive example; The terms “about” or “approximately” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such components or features may be optionally included in some embodiments, or it may be excluded.

The terms “machine learning module,” “machine learning model,” “ML model(s)”, or “artificial intelligence model(s)” refer to a machine learning or deep learning task or algorithm. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the confidence machine learning model is implemented as an XGBoost model, a clustering model, a regression model, a neural network, a random forest, a decision tree model, or a classification model. A confidence machine learning model is initially fit or trained on a training data corpus (e.g., a set of examples used to fit the parameters of the model). In some embodiments, the training data corpus may be one or more uncertainty measures, one or more natural language queries, and/or one or more predicted answers. The model may be trained on the training data corpus using supervised or unsupervised learning. The confidence machine learning model is run with the training data corpus and produces a result, which is then compared with a target, for each input vector in the training data corpus. Based on the result of the comparison and the specific learning algorithm being used, the parameters of the model are adjusted. The confidence machine learning model as described herein may make use of multiple ML engines (e.g., for analysis, transformation, and other needs).

The reliable output extraction system may train and execute different ML models for different needs and different ML-based engines. The reliable output extraction system may generate new models (based on the gathered training data corpus) and may evaluate their performance against the existing models using reliability features and ground-truth data. In the context of reliable output extraction, the reliable output extraction system may employ sophisticated uncertainty measures to efficiently improve generation of confidence features by the confidence machine learning model. The training process for the confidence machine learning model involves multiple phases: initial training on the training data corpus to learn general patterns of how uncertainty measures impact confidence of predicted answers, followed by continuous refinement based on reliability features and ground-truth data.

Such alterations, modifications, and improvements are intended to be part of this disclosure and are intended to be within the spirit and scope of the disclosure. Further, though advantages of the present disclosure are indicated, it should be appreciated that not every embodiment of the disclosure will include every described advantage. Some embodiments may not implement any features described as advantageous herein and in some instances. Accordingly, the foregoing description and drawings are by way of example only.

### Overview

Large Language Models (LLMs) are able to process and generate natural language text. However, despite significant advancements in the learning capabilities of LLMs, state-of-the-art LLMs often generate information that is factually incorrect. This unreliability precludes the use of LLMs in practical applications that have a low tolerance for factual errors. The systems, methods, and apparatuses disclosed herein resolve these shortcomings of LLMs, allowing imperfect LLMs to be used as useful sources of information in applications with low error tolerance. By deploying the disclosed reliable output extraction system comprising a prediction model and a confidence machine learning model, the extraction of reliable, factual, and correct information from imperfect LLMs is improved. Additionally, by generating confidence features and reliability features, the LLMs themselves can be improved.

General purpose LLMs (such as GPT-4) are designed and trained to be causal language models that predict the next token in a series of tokens. However, LLMs are not merely language models which emulate natural language, they may also encode factual information about the real world. Considering the enormous amounts of data that LLMs are trained on, LLMs can potentially encode any information that has been made public on the Internet. Systematic evaluations of the abilities of LLMs have shown steady improvements in their capability to learn information.

Given a token sequence as an input, an LLM outputs a probability distribution that expresses what tokens are likely to follow the input sequence. By running an LLM several times, the input token sequence can be extended with additional tokens. If the input sequence represents a question, then the generated tokens represent the LLM's response to the question. Due to the sensitivity of LLMs and how their inputs are crafted, interpreting the output of an LLM is a complex process. The reliable output extraction system disclosed herein efficiently and accurately navigates these complexities to ensure reliable extraction of factual information from LLMs.

### Example Architecture for Implementing Embodiments of the Present Disclosure

Methods, apparatuses, and computer program products of the present disclosure may be embodied by any of a variety of devices. For example, the method, apparatus, and computer program product of an example embodiment may be embodied by a networked device (e.g., an enterprise platform and/or the like), such as a server, cloud platform, or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a PDA, mobile telephone, smartphone, laptop computer, tablet computer, wearable, the like or any combination of the aforementioned devices.

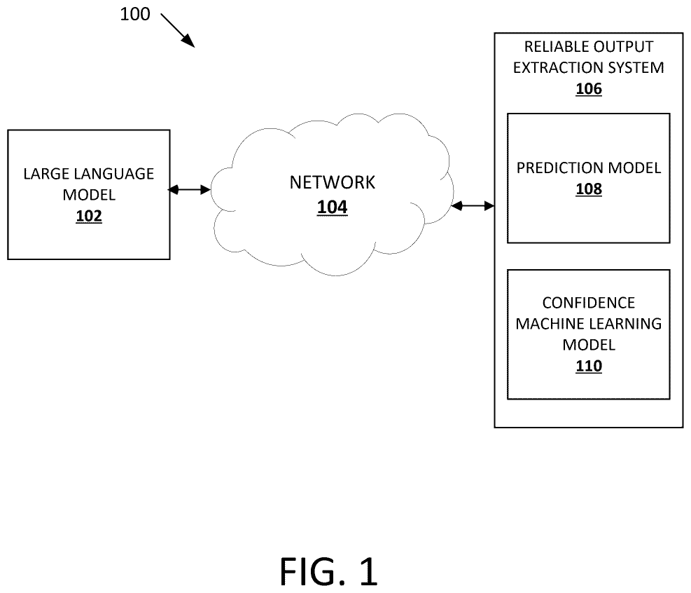

FIG. 1 illustrates an example machine learning architecture 100 within which embodiments of the present disclosure operate. The machine learning architecture 100 includes an LLM 102 configured to interact with reliable output extraction system 106 via a network 104. The reliable output extraction system 106 comprises a prediction model 108 and a confidence machine learning model 110. The machine learning architecture 100 of the reliable output extraction system 106 may include a centralized database that stores data received from an LLM 102, such as predictive responses and sets of token scores. In some embodiments, the LLM 102 may be a Visual Language Model (VLM).

The reliable output extraction system 106 is configured for automatic generation of a predictive response from an LLM 102 by applying a natural language query to the LLM 102. The natural language query comprises a sequence of tokens configured to prompt the LLM 102 for a response. In some embodiments, the natural language query may be a set of corresponding natural language queries.

The reliable output extraction system 106 is configured for automatic generation of a set of token scores from an LLM 102 by applying the natural language query to the LLM 102. The set of token scores is configured to describe the scores given to one or more tokens of the vocabulary of the LLM 102 by the LLM 102. A token score identifies a probability that a token will be included in the predictive response. Token scores provide insight into the inner workings of the LLM and are leveraged by the reliable output extraction system 106 when generating a predicted answer.

The reliable output extraction system 106 is configured to generate a prediction model 108 based on the predictive response generated by the LLM 102 and the set of token scores. The prediction model 108 employs a classifier to leverage the set of token scores to generate a predicted answer to the natural language query. Because LLMs are configured to predict the next token in a sequence, high token scores may be assigned to certain tokens even if the LLM has no factual knowledge regarding the natural language query. For example, if the natural language query is a yes-or-no question, the tokens representing both “yes” and “no” will likely be given high token scores since they are the most likely answers to a yes-or-no question, despite only one of them being correct. To overcome this, the classifier is configured to provide a weighted adjustment to the predicted answer based on the set of token scores to correct for any bias that may be present in the predictive response generated by the LLM 102.

The reliable output extraction system 106 is configured to determine one or more uncertainty measures. In some embodiments, an uncertainty measure may be an intrinsic uncertainty measure or an extrinsic uncertainty measure. In some embodiments, intrinsic uncertainty measures and extrinsic uncertainty measures are not mutually exclusive. In this regard, a single uncertainty measure may comprise both intrinsic and extrinsic uncertainty information. An uncertainty measure is a variable that is positively correlated with information correctness of an output based on an input. Intrinsic uncertainty measures are based on data generated by the LLM 102. In this regard, intrinsic uncertainty measures are internal to the LLM 102. Extrinsic uncertainty measures are based on external data not generated by the LLM 102. In this regard, extrinsic uncertainty measures are external to the LLM 102. Uncertainty measures are utilized to generate and train a confidence machine learning model 110.

The reliable output extraction system 106 is configured to generate a confidence machine learning model 110 based on the one or more uncertainty measures. In some embodiments, two confidence machine learning models are generated: one for processing affirming predicted answers (e.g., answering “yes” to a yes-or-no question) and one for processing negating predicted answers (e.g., answering “no” to a yes-or-no question). In some embodiments, the confidence machine learning model 110 comprises a hierarchical confidence model. In this regard, for example, a hierarchical confidence model may be preferred in non-binary embodiments, such as use cases involving categorizations and regressions, as opposed to yes-or-no or good-or-bad binary use cases.

The reliable output extraction system 106 is configured to determine a confidence feature by applying the natural language query and the predicted answer to a confidence machine learning model 110. A confidence feature describes a confidence (e.g., a likelihood) that the predicted answer is a correct and factual answer to the natural language query based on the one or more uncertainty measures.

The reliable output extraction system 106 is configured to determine a reliability feature of the predicted answer based on a confidence feature and a confidence threshold. For example, if a confidence feature satisfies a confidence threshold, the corresponding reliability feature indicates a high likelihood that the predicted answer embodies a correct and factual response to the natural language query, thus indicating that the predicted answer is to be extracted by the reliable output extraction system 106. Conversely, if a confidence feature does not satisfy a confidence threshold, the corresponding reliability feature indicates a low likelihood that the predicted answer embodies a correct and factual response to the natural language query, thus indicating that the predicted answer is to be discarded by the reliable output extraction system 106.

The reliable output extraction system 106 is configured to extract one or more reliable predicted answers from a set of predicted answers based on one or more reliability features. For example, for a set of natural language queries and associated predicted answers, only a subset of the predicted answers are extracted as a set of predicted answers while other predicted answers are discarded based on their respective reliability features.

Components of the machine learning architecture 100 utilize one or more data repositories (e.g., share code repository, and others that are not shown) configured to store one or more data objects and/or data for one or more component objects associated therewith. In some embodiments, the one or more data objects stored in the data repository may include and/or may be stored with data sent to and/or received from the one or more components of machine learning architecture 100. The data repository includes one or more storage units, such as multiple distributed storage units that are connected through a computer network. Each storage unit in the data repository stores one or more data objects. Moreover, each storage unit in the data repository includes one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

Components of the machine learning architecture 100 are each associated with computing devices configured to send and/or receive data directly or via a computer network, such as network 104. The LLM 102, the reliable output extraction system 106, and/or the one or more devices associated therewith are in communication using a network 104. The network 104 includes any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers and/or the like). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

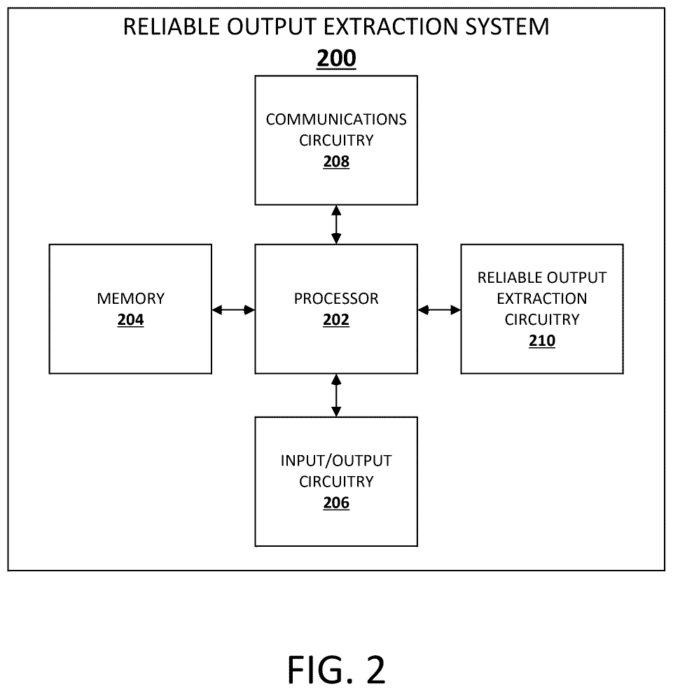

Embodiments of the present disclosure may be embodied by one or more computing systems, such as the reliable output extraction system 200 illustrated in FIG. 2. In one or more embodiments, the reliable output extraction system 200 includes processor 202, memory 204, input/output circuitry 206, communications circuitry 208, and/or reliable output extraction circuitry 210. The reliable output extraction system 200 is configured to execute the operations described herein. Although these components 202-210 are described with respect to functional limitations, it should be understood that the particular implementations necessarily include the use of particular hardware. It should also be understood that certain components 202-210 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the system. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the system to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the system, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the techniques and/or operations described herein when the instructions are executed.

In some embodiments, the reliable output extraction system 200 may include input/output circuitry 206 that may, in turn, be in communication with processor 202 to provide output to the user and, in some embodiments, to receive an indication of a user input. In some embodiments, the input/output circuitry 206 may be configured to render a user interface. Additionally or alternatively, the input/output circuitry 206 may be configured to render and/or control a display, and may comprise a web user interface, a mobile application, a query-initiating computing device, a kiosk, or the like. In some embodiments, the input/output circuitry 206 may be communicatively coupled to and/or include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the reliable output extraction system 106. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

In some embodiments, the communications circuitry 208 may act as an intermediary for one or more components of the machine learning architecture 100. For example, the communications circuitry 208 may receive and process requests, call, messages, and/or the like for one or more components of the machine learning architecture 100. In some embodiments, the communications circuitry 208 may additionally or alternatively support data routing, traffic control, security, decryption, encryption, optimization, and/or the like for data associated with one or more components of machine learning architecture 100. For example, the communications circuitry 208 may receive a data object and perform one or more subsequent actions based on the data object. In some embodiments, the communications circuitry 208 may provide functionality of a service proxy for one or more components of the machine learning architecture 100. In some embodiments, the communications circuitry 208 may also be configured to generate access logs and/or historical data including information associated with a particular computing device, component, component object, the like, or combinations thereof.

The reliable output extraction circuitry 210 may be any means such as a device or circuitry embodied in either hardware or a combination of hardware and software that is configured to interact with the machine learning architecture 100 and/or the one or more components of the machine learning architecture 100. For example, the reliable output extraction circuitry 210 may be any means such as a device or circuitry embodied in either hardware or a combination of hardware and software that is configured to interact with the LLM 102 and/or the reliable output extraction system 106.

In some embodiments, one or more external systems (such as a remote cloud computing and/or data storage system) may also be leveraged to provide at least some of the functionality discussed herein.

### Example Techniques for Implementing Embodiments of the Present Disclosure

In one embodiment, the reliable output extraction system 106 is configured to extract information from an LLM 102 with a desired factual accuracy. This involves generating a predicted answer for each pair of natural language queries and predictive responses, determining a confidence feature for each predicted answer, and extracting only predicted answers with reliability features indicating that their respective confidence feature satisfies a confidence threshold. The resulting set of reliable predicted answers is configured to have greater accuracy than the set of predictive responses.

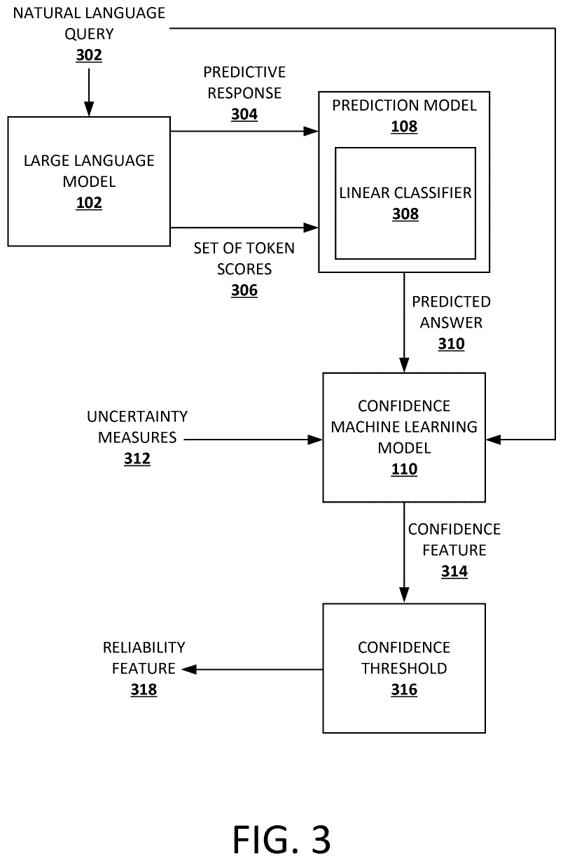

Referring now to FIG. 3, let D denote a labeled dataset indexed by i∈I and consisting of natural language query-correct answer pairs (qᵢ,yᵢ)∈D, where qᵢ is a natural language query 302 and yᵢ is the correct and factual answer to the natural language query 302. The natural language queries 302 are applied to the LLM 102, which is configured to generate a predictive response 304 and a set of token scores 306.

In some embodiments, for each natural language query 302 in the dataset, a prediction model 108 generates a predicted answer 310, denoted y\hat{ }_{I}, which is considered correct if y\hat{ }ᵢ=yᵢ. For each predicted answer 310, the confidence machine learning model 110 determines a confidence feature 314, denoted cᵢ∈[0,1]. A confidence feature 314 is an estimated probability that the corresponding predicted answer 310 is correct.

In some embodiments, a confidence threshold 316, denoted r, is used to determine a reliability feature 318. A reliability feature 318 describes a confidence feature 314 that satisfies the confidence threshold 316 as cᵢ≥τ indicating that the corresponding predicted answer 310 is to be extracted by the reliable output extraction system 106. A reliability feature 318 describes a confidence feature 314 that does not satisfy the confidence threshold 316 as cᵢ<τ indicating that the corresponding predicted answer 310 is to be discarded by the reliable output extraction system 106. In some embodiments, a predicted answer 310 that does not satisfy the confidence threshold 316 may not be discarded but applied instead to an alternate information source (e.g., an alternate LLM) in an attempt to generate output with a better confidence feature.

In some embodiments, a reliability feature 318 may be non-binary. For example, a reliability feature 318 may correspond to a graded scale. In this regard, the reliable output extraction system 106 may handle a predicted answer 310 in differently when using the graded scale as opposed to a binary confidence threshold.

A confidence machine learning model 110 is useful for enabling extraction of information from an LLM 102 with high confidence if, for a chosen high confidence threshold 316, the confidence machine learning model 110 is able to consistently output confidence features 314 that satisfy the confidence threshold 316 and is conservatively calibrated for that confidence threshold 316. To achieve this, the confidence machine learning model 110 takes as input a predicted answer 310, a natural language query 302, and one or more uncertainty measures 312.

Basing the confidence features 314 solely on outputs from the LLM 102 is problematic because an LLM 102 can only express uncertainty that it has learned. Intrinsic uncertainty measures are used to quantify the uncertainty of LLM 102 outputs. Examples of intrinsic uncertainty include the entropy of the LLM's 102 next-token probability assignments, the semantic entropy of its natural language text generations, and the detection of internal computational patterns that are associated with uncertainty. For machine learning models in general, intrinsic uncertainty alone can be a poor indicator of prediction correctness for out-of-distribution inputs for which the model has not learned to express uncertainty. External information, referred to as extrinsic uncertainty, is crucial for determining the confidence features 314 by enabling the confidence machine learning model 110 to incorporate extrinsic uncertainty measures not captured by the outputs of the LLM 102. By incorporating both intrinsic uncertainty measures and extrinsic uncertainty measures, the confidence machine learning model 110 can detect incorrect predictive answers 310 even when the LLM's 102 outputs express low uncertainty.

In some embodiments, an uncertainty measure is considered “universal” if it is quantitative and maintains a monotonic relationship with prediction accuracy across test sets. For instance, given two randomly selected predicted answers, the predicted answer with the lower measured uncertainty is always at least as likely to be correct as the other predicted answer. Probabilistically, this is formulated as xᵢ=f(qᵢ,y\hat{ }ᵢ) where yᵢ denotes the correct answer, and y\hat{ }ᵢ denotes the predicted answer for two natural language queries 302 indexed by i∈{1,2}. f is a universal uncertainty measure if the following inequality holds. P(y\hat{ }₁=y₁|x₁<x₂)≥P(y\hat{ }₂=y₂|x₁<x₂).

A model whose inputs are universal uncertainty measures and enforces a monotonic relationship between its inputs and its outputs generates outputs that are also monotonic with prediction accuracy. That is, confidence is maximized (though not necessarily 100% confidence) when all uncertainty measures are independently minimized and minimized when all uncertainty measures are independently maximized.

Many improvements in determining confidence features 314 are achieved by training the confidence machine learning model 110 on both intrinsic and extrinsic uncertainty measures. Doing so discourages overfitting, encourages rationality, encourages generalization, and is easy to recalibrate. The confidence feature 314 associated with a certain predicted answer 310 is bounded between the confidence features associated with predicted answers with unilaterally lower and high uncertainties. By maintaining a monotonic relationship, the confidence machine learning model 110 is prevented from learning irrational strategies that would increase confidence in response to increased uncertainty. Monotonic relationships between universal uncertainty measures (and by extension, confidence) and prediction accuracy can persist on novel sets of natural language queries that are dissimilar to the prediction model's 108 and the confidence machine learning model's 110 training sets. For test sets that are dissimilar to the confidence machine learning model's 110 training sets, conservative calibration may be maintained using recalibration methods like Platt scaling and isotonic regression.

For the purposes of explanation and to demonstrate the utility of the reliable output extraction system 106, the following examples are discussed in the context of characterizing species' occurrence in certain locations. Example templates for a natural language query 302 may include “Can [species] be found in [location]? Yes or no.” and “Is [species] absent in [location]? Yes or no.”

In some embodiments, upon applying a natural language query 302 to the LLM 102, the LLM 102 generates a set of token scores 306 by assigning a probability to all tokens in its vocabulary that a token will be the next token in the sequence. Because both “yes” and “no” are included in the LLM's vocabulary, the scores assigned to “yes” (s_{yes}) and “no” (sₙₒ) can be used to directly make a prediction y\hat{ } for each natural language query 302. In some embodiments, in an instance in which the set of token scores 306 is not directly accessible via the LLM 102, a linear classifier 308 is configured to approximate the set of token scores 306. In some embodiments, other classifiers may be used in place of the linear classifier 308. The specific classifier used is dependent on the specific use case being applied to the reliable output extraction system 106. The linear classifier 308 is defined as

$${y}^{⋀} = \{ \begin{matrix}yes : {as}_{yes} + {bs}_{no} \geq c \\ “ no ” : {as}_{yes} + {bs}_{no} < c\end{matrix} ,$$

where parameters a and b weight the token scores to correct for bias in the LLM 102 toward “yes” or “no”. It cannot be assumed that the LLM 102 weights both tokens equally. The predicted answer 310 is generated by the prediction model 108 by applying the linear classifier 308 to the predictive response 304. In some embodiments, in an instance in which the set of token scores 306 is directly accessible via the LLM 102, the predicted answer 310 is generated based directly on the predictive response 304.

In some embodiments, to train and generate the confidence machine learning model 110, uncertainty information is collected to determine uncertainty measures 312. As discussed above, intrinsic uncertainty measures are derived directly from the LLM 102. Based on a set of predictive responses 304, a number of “yes” responses (n_{yes}), “no” responses (nₙₒ), and other responses (nₒₜₕₑᵣ), can be determined. Other responses are non-answers, i.e., anything other than “yes” or “no.” From this data, the intrinsic uncertainty measures u_{llm,1}, u_{llm,2}, and u_{llm,3} are determined.

$${u}_{llm , 1} = \{ \begin{matrix}{n}_{no} : {y}^{⋀} = “ yes ” \\ {n}_{yes} : {y}^{⋀} = “ no ”\end{matrix} , {u}_{llm , 2} = \{ \begin{matrix}1 - \frac{\vert {n}_{yes} - {n}_{no} \vert}{n - {n}_{other}} , {n}_{other} < n \\ 1 : otherwise\end{matrix} ,$$

and u_{llm,3}=nₒₜₕₑᵣ.

u_{llm,1} describes the number of predicted answers 310 that agree with the predictive response 304. u_{llm,2} describes the fraction of yes-or-no responses that agree with each other, ignoring non-answers. u_{llm,3} describes the number of non-answers.

In some embodiments, the outputs of an LLM 102 can be manipulated by making seemingly superficial changes to their inputs (e.g., the natural language query 302). Oversensitivity to such changes suggest that the LLM 102 is only trying to generate predictive responses 304 that “sound right” rather than drawing from internalized factual knowledge. Thus, oversensitivity is interpreted as an indicator of uncertainty. To measure oversensitivity, the predicted answer 310 generation process is repeated with a set of natural language queries 302 that differ slightly from each other. For example, two different natural language queries 302 that ask the same question may be “Is [species] found in [location]? Yes or no.” and “Can one observe [species] in [location]? Yes or no.” For each phrasing, n predictive responses 304 are collected. For m phrasings, this results in m×n predicted answers 310 being generated by prediction model 108. Let y\hat{ }ᵢ₀ be the original predicted answer 310 associated with an original phrasing (e.g., an original natural language query 302), and y\hat{ }ᵢⱼ for j∈{1, . . . , m} be the predicted answers 310 for each different phrasing m. The uncertainty measure u_{ps,1} is the number of phrasings that resulted in predicted answers 310 that were different that the original prediction y\hat{ }ᵢ₀, as

$${u}_{ps , 1} = {\sum }_{j = 1}^{m} 1 [ {\hat{y}}_{i 0} \neq {\hat{y}}_{i j} ] .$$

In some embodiments, each prediction y\hat{ }ᵢⱼ is derived from a score sⱼ=a′n_{yes}+b′nₙₒ calculated by the linear classifier 308. Let s₀ be the score calculated for the original predicted answer 310. Uncertainty measure u_{ps,2} is defined as the variance of the scores that resulted from the different phrasings, including the original as

$${u}_{ps , 2} = {\sum }_{j = 0}^{m} \frac{{( {s}_{j} - \overline{s} )}^{2}}{m} where \overline{s} = {\sum }_{j = 0}^{m} \frac{{s}_{j}}{m + 1} .$$

Historical performance of the LLM 102 is a significant uncertainty measure. In some embodiments, historical performance of the LLM 102 is considered an extrinsic uncertainty measure. For example, knowing that that the LLM 102 correctly responded to the natural language query 302 “Can Acer saccharum be found in the Florida Keys? Yes or no.” could improve the confidence that the LLM 102 can correctly respond to a similar query such as “Can Acer saccharum be found in Miami? Yes or no.” To quantify historical performance, historical natural language queries, historical predicted answers 310 and historical reliability features are stored in the centralized database. For example, the accuracy of the LLM 102 on a reference set for queries with shared elements (e.g., a shared species and/or shared location) can then be determined. Different query elements have different impacts on the output generated by the LLM 102, so separate uncertainty measures are determined for each query element (e.g., species, location, occurrence status). Higher accuracy implies lower uncertainty, so the uncertainty measure for historical performance is defined as uₕₚ=1−accuracy.

In some embodiments, more indirect relationships are also considered between query elements (e.g., query locations being proximate to each other, query species belonging to the same taxonomic grouping, and/or the like). These indirect relationships may be less informative of uncertainty, but they allow for larger datasets to be formed to determine the historical performance uncertainty measure uₕₚ. In some embodiments, indirect relationships are considered extrinsic uncertainty measures.

In some embodiments, the context available on a subject in the LLM's 102 training set is indicative of uncertainty. In some embodiments, context available on a subject in the LLM's 102 training set is considered an extrinsic uncertainty measure. For example, for a species with n_{records} records available in the LLM's 102 training set, the uncertainty measure u_{context} is defined as

$${u}_{context} = \frac{1}{{n}_{records}} .$$

In some embodiments, for example, u_{context} may be approximated based on word count data from internet search engine trend data.

An LLM's 102 subject expertise is also used as an uncertainty measure. In some embodiments, subject expertise of the LLM 102 is considered an extrinsic uncertainty measure. If the LLM 102 is able to correctly respond to a query related to the natural language query 302, the confidence feature 314 may be increased. For example, a correct response to the query “What taxonomic phylum does the species Acer saccharum belong to? Only say its name.” may increase the confidence feature 314 resulting from the natural language query 302 “Is Acer saccharum present in the Florida Keys? Yes or no.” An LLM 102 may also be trained on outdated data, which may lead to generation of predictive responses 304 that were correct at one point in the past but are no longer correct. An example uncertainty measure for the subject expertise on taxonomic classification is defined as

$${u}_{tax} = {\sum }_{j = 1}^{m} 1 [ {t}_{j} ∉ T ]$$

where T represents a set of known taxonomic classifications, and tⱼ, j∈1, . . . , m represents m responses sampled from the LLM 102 when repeating the natural language query m times. uₜₐₓ represents the number of times a predictive response 304 did not match a member of the set T.

In some embodiments, when the natural language query 302 represents a yes-or-no question the relationships between uncertainty and confidence can depend on what was predicted. Because of this, it may be beneficial to train two separate confidence machine learning models. One for processing “yes” predicted answers 310 and one for processing “no” predicted answers 310. To generate a confidence feature 314, the appropriate confidence machine learning model is selected by reliable output extraction system 106. As another example, one confidence machine learning model may be used to process predicted answers that predict the presence of a species in a location, while a different confidence machine learning model may be used to process predicted answers that predict the absence of a species in a location.

### Example Techniques for Evaluating the Performance of Embodiments of the Present Disclosure

To evaluate the performance of the reliable output extraction system 106, D is used as a reference dataset. As discussed above, D comprises natural language query-correct answer pairs as (qᵢ,yᵢ)∈D. In accordance with the process described above, each natural language query qᵢ is applied to an LLM. The LLM then generates a predictive response and a set of token scores. A prediction model uses a linear classifier to correct any bias internal to the LLM to generate a predicted answer. The uncertainty measures described above are determined and used to train a confidence machine learning model. The confidence machine learning model generates a confidence feature based on the predicted answer, the natural language query, and the uncertainty measures. A confidence threshold is used to generate a reliability feature based on the confidence feature. Performance metrics such as accuracy, precision, and recall are determined by comparing the reliability features to the correct answers yᵢ.

In some embodiments, the confidence machine learning model uses an XGBoost algorithm. In some embodiments, the confidence machine learning model is validated using five-fold cross validation.

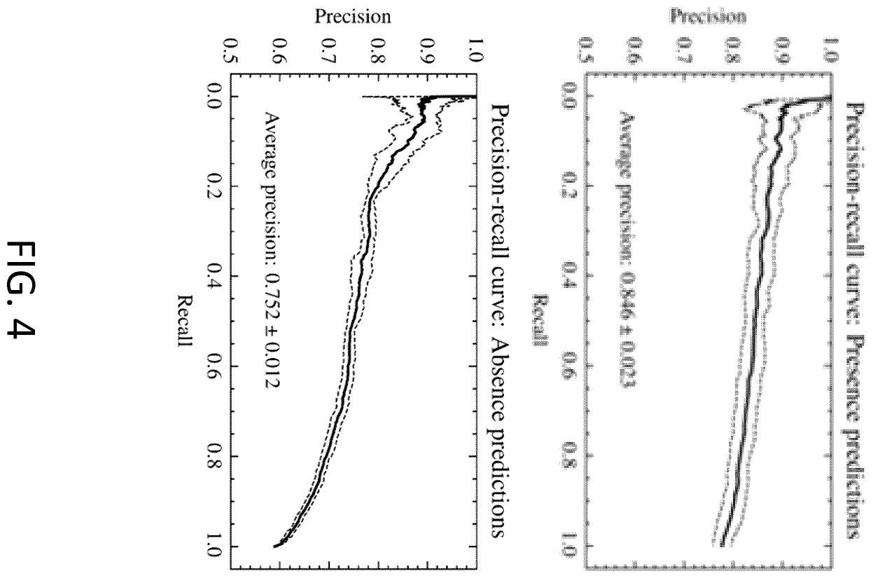

FIG. 4 depicts example experimental results as a Precision-Recall Curve for Presence Predictions (e.g., predicted answers predicting presence of a species at a location) and as a Precision-Recall Curve for Absence Predictions (e.g., predicted answers predicting absence of a species at a location). The solid lines represent the mean values across many iterations of the experiment on different reference datasets D. The dotted lines represent one standard deviation from the mean. In both curves, lower recall values correlate with higher precision values. Although the overall accuracy of absence predictions is lower than that of the presence predictions, the confidence machine learning model used to process absence predictions produced a larger range of precision values, indicating superior performance in discriminating between correct and incorrect predictions. However, because presence prediction accuracy was much higher overall (77% accuracy compared to 57% on absence predictions), confidence for presence predictions has much less room for improvement. The precision of absence predictions only reaches the overall accuracy of presence predictions at 30% recall.

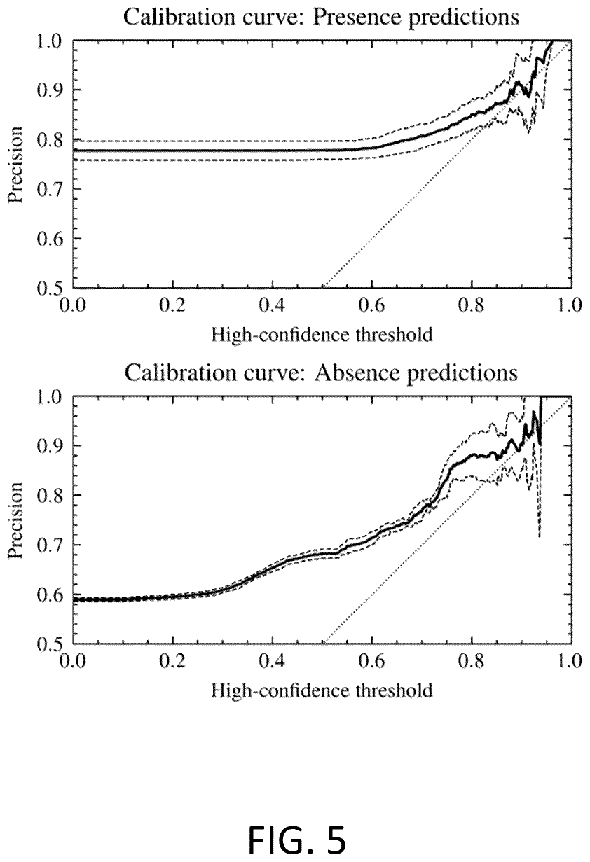

FIG. 5 depicts example experimental results as a Calibration Curve for Presence Predictions and as a Calibration Curve for Absence Predictions. To be conservatively calibrated, a confidence machine learning model may underestimate, but not overestimate, the accuracy of predicted answers. As discussed above, the solid lines represent the mean values across many iterations of the experiment on different reference datasets D. The dotted lines represent one standard deviation from the mean. The straight dotted lines represents the minimum precisions needed for confidence estimates to be conservatively calibrated at each confidence threshold. For example, in order to be conservatively calibrated to satisfy a confidence threshold of 0.5, the confidence machine learning model must perform at a precision of at least 0.5. As shown, the expected precision for a conservatively calibrated confidence machine learning model is lower-bounded by the confidence threshold. FIG. 3 illustrates that both the confidence machine learning model that processed presence predictions and the confidence machine learning model that processed absence predictions achieved conservative calibration for confidence thresholds under 0.85. Although the mean precision sometimes falls below the desired confidence threshold above 0.85 the mean precision for both confidence machine learning models generally exceeds the confidence threshold.

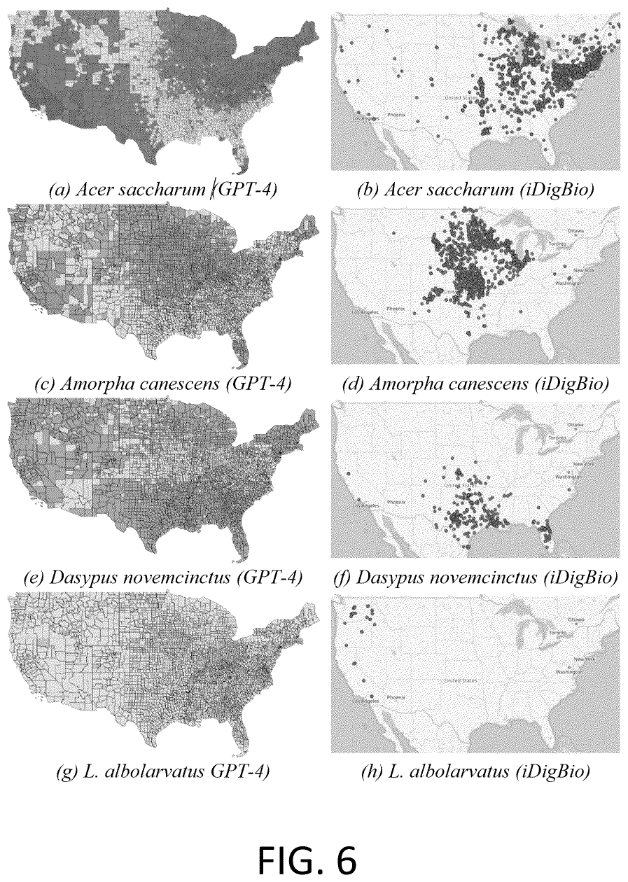

FIG. 6 illustrates occurrence patterns for four species as heat maps. In the left column, red color indicates a presence prediction for the species and blue color indicates an absence prediction for the species. In the right column, green color indicates correct, factual presences of the species. FIG. 6 visualizes the intuition that most uncertainty should occur at the borders of presence and absence.

### CONCLUSION

Various embodiments of the disclosure represent an architecture and a method that enable reliable output extraction. Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. A method comprising:
generating a predictive response and a set of token scores by applying a natural language query to a large language model;
generating a predicted answer to the natural language query based on the set of token scores;
determining one or more uncertainty measures, wherein a confidence machine learning model is generated based on the one or more uncertainty measures;
determining a confidence feature by applying the natural language query and the predicted answer to confidence machine learning model; and
determining a reliability feature of the predicted answer based on the confidence feature and a confidence threshold.

2. The method of claim 1, wherein determining the one or more uncertainty measures further comprises:
determining one or more intrinsic uncertainty measures based on the predictive response and the set of token scores; and
determining one or more extrinsic uncertainty measures based on external data associated with the natural language query.

3. The method of claim 1, further comprising:
generating a first confidence machine learning model and a second confidence machine learning model based on the one or more uncertainty measures;
in an instance in which the predicted answer affirms the natural language query, determining a confidence feature by applying the natural language query and the predicted answer to the first confidence machine learning model; and
in an instance in which the predicted answer negates the natural language query, determining a confidence feature by applying the natural language query and the predicted answer to the second confidence machine learning model.

4. The method of claim 1, wherein generating the predicted answer comprises:
generating a prediction model based on the predictive response and a classifier, wherein the prediction model is configured to generate the predicted answer to the natural language query, and wherein the classifier is configured to weigh the predicted answer based on the set of token scores.

5. The method of claim 4, further comprising:
generating the classifier based on the predictive response and the set of token scores.

6. The method of claim 1, wherein the predicted answer is not equivalent to the predictive response.

7. The method of claim 1, further comprising:
extracting a reliable predicted answer based on the predicted answer and the reliability feature.

8. The method of claim 1, further comprising:
discarding an unreliable predicted answer based on the predicted answer and the reliability feature.

9. A system comprising one or more processors and memory including computer program code instructions, the computer program code instructions configured to, when executed by the one or more processors, cause the system to:
generate a predictive response and a set of token scores by applying a natural language query to a large language model;
generate a predicted answer to the natural language query based on the set of token scores;
determine one or more uncertainty measures, wherein a confidence machine learning model is generated based on the one or more uncertainty measures;
determine a confidence feature by applying the natural language query and the predicted answer to confidence machine learning model; and
determine a reliability feature of the predicted answer based on the confidence feature and a confidence threshold.

10. The system of claim 9, wherein the computer program code instructions are further configured to, when executed by the one or more processors, cause the apparatus to determine the one or more uncertainty measures further by:
determining one or more intrinsic uncertainty measures based on the predictive response and the set of token scores; and
determining one or more extrinsic uncertainty measures based on external data associated with the natural language query.

11. The system of claim 9, wherein the computer program code instructions are further configured to, when executed by the one or more processors, cause the apparatus to:
generate a first confidence machine learning model and a second confidence machine learning model based on the one or more uncertainty measures;
in an instance in which the predicted answer affirms the natural language query, determine a confidence feature by applying the natural language query and the predicted answer to the first confidence machine learning model; and
in an instance in which the predicted answer negates the natural language query, determine a confidence feature by applying the natural language query and the predicted answer to the second confidence machine learning model.

12. The system of claim 9, wherein the computer program code instructions are further configured to, when executed by the one or more processors, cause the apparatus to generate the predicted answer by:
generating a prediction model based on the predictive response and a classifier, wherein the prediction model is configured to generate the predicted answer to the natural language query, and wherein the classifier is configured to weigh the predicted answer based on the set of token scores.

13. The system of claim 12, wherein the computer program code instructions are further configured to, when executed by the one or more processors, cause the apparatus to:
generate the classifier based on the predictive response and the set of token scores.

14. The system of claim 9, wherein the predicted answer is not equivalent to the predictive response.

15. The system of claim 9, wherein the computer program code instructions are further configured to, when executed by the one or more processors, cause the apparatus to:
extract a reliable predicted answer based on the predicted answer and the reliability feature.

16. The system of claim 9, wherein the computer program code instructions are further configured to, when executed by the one or more processors, cause the apparatus to:
discard an unreliable predicted answer based on the predicted answer and the reliability feature.

17. A computer program product comprising at least one non-transitory computer-readable storage medium having computer executable program code instructions therein, the computer executable program code instructions configured, upon execution, to:
generate a predictive response and a set of token scores by applying a natural language query to a large language model;
generate a predicted answer to the natural language query based on the set of token scores;
determine one or more uncertainty measures;
generate a confidence machine learning model based on the one or more uncertainty measures;
determine a confidence feature by applying the natural language query and the predicted answer to confidence machine learning model; and
determine a reliability feature of the predicted answer based on the confidence feature and a confidence threshold.

18. The computer program product of claim 17, wherein the computer executable program code instructions are configured, upon execution, to cause the computer program product to determine the one or more uncertainty measures further by:
determining one or more intrinsic uncertainty measures based on the predictive response and the set of token scores; and
determining one or more extrinsic uncertainty measures based on external data associated with the natural language query.

19. The computer program product of claim 17, wherein the computer executable program code instructions are configured, upon execution, to cause the computer program product to:
generate a first confidence machine learning model and a second confidence machine learning model based on the one or more uncertainty measures;
in an instance in which the predicted answer affirms the natural language query, determine a confidence feature by applying the natural language query and the predicted answer to the first confidence machine learning model; and
in an instance in which the predicted answer negates the natural language query, determine a confidence feature by applying the natural language query and the predicted answer to the second confidence machine learning model.

20. The computer program product of claim 17, wherein the computer executable program code instructions are configured, upon execution, to cause the computer program product to generate the predicted answer by:
generating a prediction model based on the predictive response and a classifier, wherein the prediction model is configured to generate the predicted answer to the natural language query, and wherein the classifier is configured to weigh the predicted answer based on the set of token scores.
